(19) United States
(12) Patent Application Publication
(10) Pub. No.: US 2006/0090561 A1
(43) Pub. Date: May 4, 2006

(54) METHOD AND APPARATUS FOR MEASUREMENT OF CUSTOM FOOT ORTHOSES

(75) Inventors: WILLIAM PHILIP BORS, LYLES, TN (US); EDWARD S. GLASER, LYLES, TN (US)

Correspondence Address: WILLIAM P. BORS, 7674 HWY 7, LYLES, TN, 37098, US

(73) Assignee: SOLE SUPPORTS, INC., LYLES, TN (US)

(21) Appl. No.: 10/904,270

(22) Filed: Nov. 2, 2004

(51) Int. Cl. G01M 19/00

(52) U.S. Cl. 73/172

(57) ABSTRACT

As with orthotics that are all custom devices molded through a proprietary foam and plaster method and are designed to fit the plantar surface of the foot with full contact, it is necessary to provide a method of applying pressure to the orthotic in a manner that mimics the manner in which a foot applies pressure to it. This is done by applying pressure to a loose fitting diaphragm that is contained within a rigid frame so as to limit expansion of the diaphragm past the boundaries of the device. Further the device contains the diaphragm in such a manner that the diaphragm; 1) Exerts minimal force on the orthotic so as not to bias the deflection of the orthotic by the mechanical pressure of the diaphragm. 2) Uses minimal force to expand the diaphragm so as not to bias the pressure reading indicating how much force is being applied to the orthotic. 3) Closes in such a manner that pushes and holds the orthotic device up against the measuring rod, front window and bottom reference baseplate. 4) Allows direct observation of the orthotic while it is progressing through a measurement cycle. 5) Exerts force evenly over the entire orthotic so as not to apply pressure at a point that would distort the orthotic and cause the orthotic to change the spring rate and cause a reading that would not normally happen. The design of the invention must also be robust so as to preclude opening while the orthotic is under pressure as the separating force on the latches can be well over 2000 pounds and the risk of subsequent operator injury with such a large air spring.

A method and apparatus for the measurement of a custom foot orthotic to determine how much displacement of the orthotic will occur when force is applied to it.

As a custom orthotic is designed to be in full contact with the plantar surface of the foot, a method of applying a uniform force (pressure) to the orthotic is necessary. This is accomplished by using a flexible gum rubber diaphragm that is mounted on a sub frame and enclosed within a main frame. The main frame has a transparent window in it to allow placement and observation of the orthotic as it goes through a measurement cycle.

Further there is a rod that is placed at the apex of the orthotic that drives a pulse encoder to measure the distance of displacement during the measurement cycle. This goes to a counter and the number of counts representing the distance displaced is displayed at the end of a measurement cycle.

Further, there is a digital pressure gauge that provides a switched electrical output at a set point.

### BACKGROUND OF THE INVENTION

In the manufacturing of a custom foot orthotic, a method of measurement of the deflection (spring rate) versus the amount of force (pressure) applied to it has previously been done in a subjective and inaccurate manner. Most of the time performed by a person pushing down on the apex of the orthotic and applying an educated guess as to the factors of:
1) Foot size
2) Patient weight
3) Foot flexibility
4) Height of arch apex
5) Length of arch apex
6) Other subjective factors

It is also a necessary task to match the left and right orthotics to each other. If mismatched they will cause an aberration in the gait cycle and cause the patient discomfort or injury. Further the subjective measurement differences between different operators lend the measurements to have no measurable accuracy.

Further depending upon environmental and emotional factors the operators will not give the same readings subsequent days.

The particular features and advantages of this invention will become apparent from the following description taken in connection with the accompanying drawings in which:

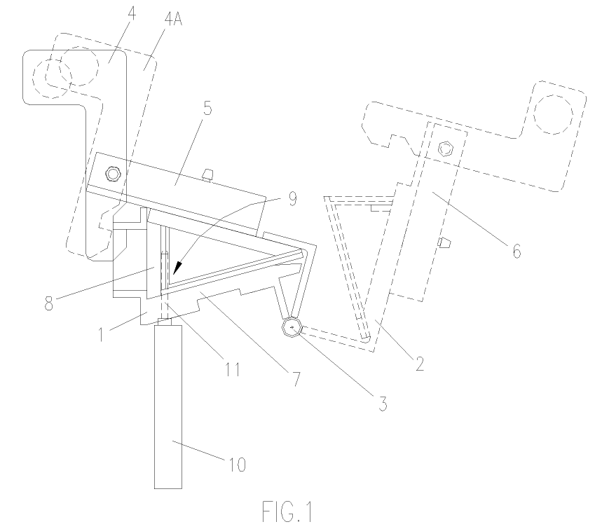

FIG. 1 is a side view of the invention illustrating how the top cover (subframe) hinges out of the way and allows for insertion/removal of the orthotic under test. Furthermore, the arrow shows the rotation of the top cover and how it vector pushes the orthotic up against the reference surface/s. It further shows the substantial latching mechanism.

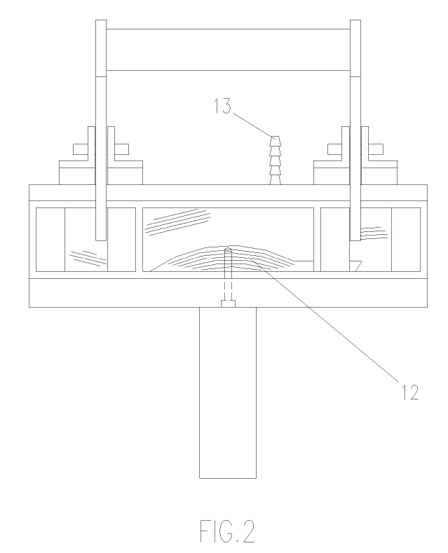

FIG. 2 shows the front view of the invention and depicts the orthotic placement in the device. It further shows how the air pressure is applied to the invention.

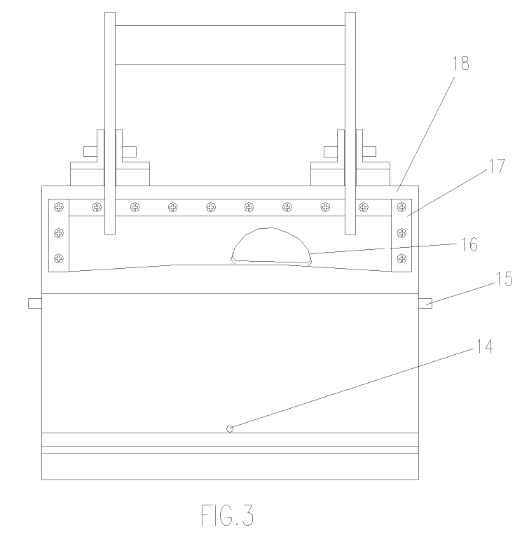

FIG. 3 is a top view of the invention showing how the diaphragm is affixed to the top subframe.

FIG. 4 is the front view with accompanying block diagrams describing the measurement electronics and the measurement cycle.

### DESCRIPTION OF THE EMBODIMENT OF THE APPARATUS AND METHOD

Referring now the drawings, FIG. 1, the apparatus is constructed with fixed main frame 1 and affixed with a hinge 3 is a movable sub frame 2. A latching mechanism 4 is shown in the latched position and the unlatched position 4A. The invention is shown with the sub frame 2 in the closed position 5 and the open position 6. The main frame 1 is so constructed as to have a reference baseplate 7 and a reference viewing window 8. The reference viewing window is constructed out of polycarbonate so as to be able to view the deflection of the orthotic while under pressure. The invention is so constructed that when the sub frame is in the open position 6 an orthotic may be placed in the device on the reference baseplate 7 and the viewing window 8 the orthotic is securely held against the reference baseplate 7 and the viewing window 8 as a result of the vector of force shown by arrow 9. Linear electronic encoder 10 and plunger of encoder 11 are utilized to measure the distance the apex of the orthotic is displaced under pressure during the measurement cycle.

FIG. 2 is the front view of the invention and illustrates how the orthotic 12 is placed within the invention and further illustrates where the air pressure is applied to the sub frame diaphragm through fitting 13.

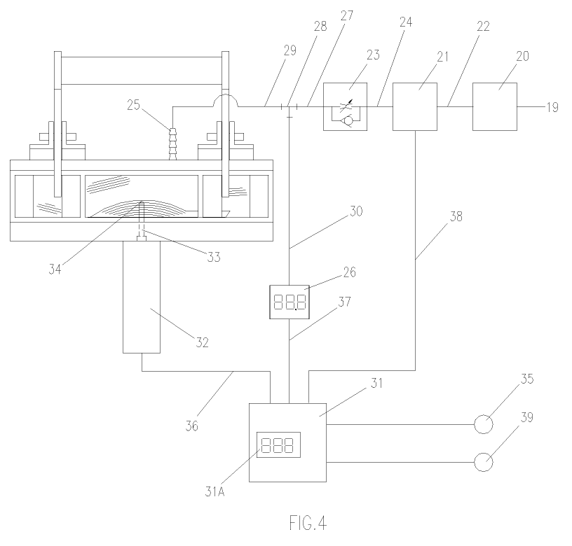

FIG. 3 illustrates the top view of the invention with the sub frame shown in the open position (see FIG. 1-6). The plunger end of the linear encoder 14 is shown at the front of the invention. The hinge pin 15 is shown in this view. A cutaway view of the rubber diaphragm 16 is used to illustrate the opening behind the diaphragm, which is pressurized during the measurement cycle. The sealing strips 17 are utilized to hold the diaphragm in place and to seal off the internal portion of the of the subframe 18.

FIG. 4 is a block diagram of the invention illustrating the function and operation of the control electronics and method of operation. There is a source of compressed air 19 supplied to a filter/regulator unit 20. This is supplied to a solenoid valve 21 through hose 22. The output of the solenoid valve is connected to a pneumatic flow control 23 through hose 24. The pneumatic flow control is a ball check type of flow control where the airflow through the valve is restricted in the direction going towards the inlet of the sub frame 25 and the digital pressure gauge 26, through hose 27, tee 28 and hoses 29 and 30. When solenoid valve 21 is reversed allowing the system to exhaust, the pneumatic flow control valve 23 flows freely with little restriction. The measurement cycle is performed in the following manner. The controller 31 for the system is a standard programmable logic controller (plc) with digital inputs and outputs and contains a counter and display. An orthotic is manually inserted into the invention and the sub frame is closed and latched (see FIG. 1-5). This holds the orthotic in position as previously explained against the reference surfaces and depresses the linear encoder 32 plunger 33 to the height of the orthotic apex 34. When the start pushbutton 35 is depressed:
a. The internal plc 31 counter 31A is reset to 0.
b. A signal is sent through cable 38 to solenoid valve 21 actuating it and allowing air to flow through the flow control 23 and to the pressure gauge 26 and sub frame inlet 25.

As the pressure increases it exerts a downward force on the orthotic and causes the plunger 33 to be displaced downward sending a string of electronic pulses through cable 36 to the counter in plc 31. The digital pressure gauge 26 is equipped with a programmable set point. When the pre-programmed set point is reached a signal is sent through cable 37 to the plc 31. At that event:
a. The plc 31 counter 31A is frozen and displaying the accumulated counts.
b. The signal is removed from the solenoid valve 21 allowing it to shift automatically to the exhaust position.

At anytime the sequence of events may be interrupted by depressing the stop pushbutton 39.

What is claimed is:

1. A method and apparatus for the measurement of a custom foot orthotic to determine the amount of displacement of the apex of said orthotic versus the amount of pressure evenly applied to it.

2. A method for using the force applied as a reference and not a variable in the measurement cycle as described in claim 1., wherein the set point of the force applied becomes the constant and the amount of displacement of the apex of said orthotic the variable in an equation to determine the amount of upward force applied by the orthotic to the plantar surface of the patients foot it is custom made for. Further, using this method as an algorithm for the determination of a specific amount of force also may be used as a method for the comparison of sets of orthotics with other sets of orthotics. Further, the method may be modified to allow the amount of measured displacement of the apex of an orthoses to become fixed and therefore the variable become the amount of force applied evenly to the orthoses.

3. A method of universally applying force to the surface of an orthotic in an even manner that closely mimics the way the plantar surface of the foot applies force to an orthotic custom made for that foot.

4. A method and apparatus that universally takes any orthotic and allows it to be referenced to zero no matter what the height of the apex of said orthoses are by resetting the distance counter to 0 at the beginning of the measurement cycle.

5. A method of applying force to the upper surface of the orthotic in a manner that does not distort the orthoses and thereby invalidate the force or distance measurements.

6. As a method and apparatus for the matching of the orthotics in reference to each other to insure even plantar pressure applied by the orthotics to the ultimate patient or user of the orthoses.

7. As a method to quantize and save for future records and remanufacture a custom orthotic that matches the previous one/s.

8. A method and apparatus for affixing said orthotic in the correct position within the invention for measurement in one motion during the closure of the sub frame of said invention.
